(19) United States
(12) Patent Application Publication
(10) Pub. No.: US 2007/0235904 A1
(43) Pub. Date: Oct. 11, 2007

(54) Method of forming a chemical mechanical polishing pad utilizing laser sintering

(76) Inventor: Alan H. Saikin, Landenberg, PA (US)

Correspondence Address: ROHM AND HAAS ELECTRONIC MATERIALS;CMP HOLDINGS, INC., 451 BELLEVUE ROAD, NEWARK, DE, 19713, US

(21) Appl. No.: 11/400,401

(22) Filed: Apr. 6, 2006

(51) Int. Cl. B29C 35/08; B29C 41/02

(52) U.S. Cl. 264/497; 264/113

(57) ABSTRACT

The present invention provides a method of manufacturing a porous chemical mechanical polishing pad. The method comprises retracting a retractable surface to form a sintering chamber and dispensing thermoplastic particles into the sintering chamber via a dispenser. The method further provides focusing a laser beam from a laser onto the thermoplastic particles and selectively sintering the thermoplastic particles with the laser beam.

### FIELD OF THE INVENTION

The present invention relates to a method of forming polishing pads used for chemical-mechanical planarization (CMP), and in particular relates to a method of forming a polishing pad using laser sintering.

### BACKGROUND OF THE INVENTION

In the fabrication of integrated circuits and other electronic devices, multiple layers of conducting, semiconducting, and dielectric materials are deposited on or removed from a surface of a semiconductor wafer. Thin layers of conducting, semiconducting, and dielectric materials may be deposited by a number of deposition techniques. Common deposition techniques in modern processing include physical vapor deposition (PVD), also known as sputtering, chemical vapor deposition (CVD), plasma-enhanced chemical vapor deposition (PECVD), and electrochemical plating (ECP).

As layers of materials are sequentially deposited and removed, the uppermost surface of the substrate may become non-planar across its surface and require planarization. Planarizing a surface, or “polishing” a surface, is a process where material is removed from the surface of the wafer to form a generally even, planar surface. Planarization is useful in removing undesired surface topography and surface defects, such as rough surfaces, agglomerated materials, crystal lattice damage, scratches, and contaminated layers or materials. Planarization is also useful in forming features on a substrate by removing excess deposited material used to fill the features and to provide an even surface for subsequent levels of metallization and processing.

Chemical mechanical planarization, or chemical mechanical polishing (CMP), is a common technique used to planarize substrates such as semiconductor wafers. In conventional CMP, a wafer carrier or polishing head is mounted on a carrier assembly and positioned in contact with a polishing pad in a CMP apparatus. The carrier assembly provides a controllable pressure to the substrate urging the wafer against the polishing pad. The pad is moved (e.g., rotated) relative to the substrate by an external driving force. Simultaneously therewith, a chemical composition (“slurry”) or other fluid medium is flowed onto the substrate and between the wafer and the polishing pad. The wafer surface is thus polished by the chemical and mechanical action of the pad surface and slurry in a manner that selectively removes material from the substrate surface.

Conventional methods of manufacturing polishing pads include, for example, cast and skiving of mix polyurethane precursors and pore forming agents, impregnation and splitting of non-woven felt, and coating, coagulation and buffing on a modified non-woven felt. In addition, other methods for manufacturing polishing pads have been explored, including, photopolymerization of liquid precursors, net-shape molding, extrusion of thermo-formable polymers and sintering of polymeric powders (e.g., U.S. Pat. No. 6,017,265).

Sintering typically involves two or more thermoplastic polymers that are compacted under pressure, above the glass transition temperature. The mixture of the thermoplastics is place in a mold and exposed to the sintering condition. The end result is a pad with uniform dimensions and porosity. Unfortunately, the pad typically requires additional processing steps, such as, machining of grooves in order to create a functional pad. In addition, conventional sintering techniques are limited in forming polishing pads with varied porosity and material composition.

Accordingly, what is needed is a method of forming a polishing pad for chemical-mechanical planarization utilizing improved sintering techniques.

### SUMMARY OF THE INVENTION

In one aspect of the invention, there is provided a method of manufacturing a porous chemical mechanical polishing pad comprising: retracting a retractable surface to form a sintering chamber; dispensing thermoplastic particles into the sintering chamber via a dispenser; focusing a laser beam from a laser onto the thermoplastic particles; and selectively sintering the thermoplastic particles with the laser beam.

In another aspect of the invention, there is provided a method of manufacturing a porous chemical mechanical polishing pad comprising: retracting a retractable surface to form a first sintering chamber; dispensing first thermoplastic particles into the first sintering chamber via a dispenser; focusing a laser beam from a laser onto the first thermoplastic particles; selectively sintering the first thermoplastic particles with the laser beam; retracting the retractable surface to form a second sintering chamber; dispensing second thermoplastic particles into the second sintering chamber via the dispenser; focusing the laser beam from the laser onto the second thermoplastic particles; and selectively sintering the second thermoplastic particles with the laser beam.

In another aspect of the invention, there is provided a method of manufacturing a porous chemical mechanical polishing pad comprising: retracting a retractable surface to form a first sintering chamber; dispensing thermoplastic particles into the first sintering chamber via a dispenser; focusing a laser beam from a laser onto the thermoplastic particles; selectively sintering the thermoplastic particles with the laser beam; retracting the retractable surface to form a second sintering chamber; dispensing the thermoplastic particles into the second sintering chamber via the dispenser; focusing the laser beam from the laser onto the thermoplastic particles; and selectively sintering the thermoplastic particles with the laser beam.

### BRIEF DESCRIPTION OF THE DRAWINGS

FIG. 1 illustrates the method of forming a polishing pad utilizing the laser sintering apparatus of the present invention;

FIG. 2 illustrates the method of forming a polishing pad utilizing the laser sintering apparatus of the present invention;

FIG. 3 illustrates the method of forming a polishing pad utilizing the laser sintering apparatus of the present invention;

FIG. 4 illustrates the method of forming a polishing pad utilizing the laser sintering apparatus of the present invention;

FIG. 5 illustrates the method of forming a polishing pad utilizing the laser sintering apparatus of the present invention; and

FIG. 6 illustrates various pad configurations formed using the method of the present invention.

### DETAILED DESCRIPTION OF THE INVENTION

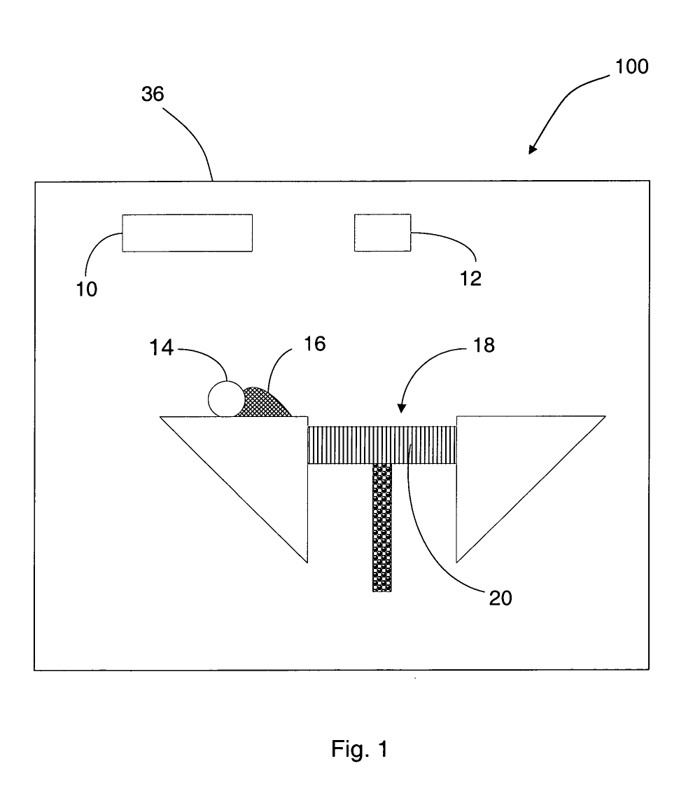

Referring now to the drawing, FIG. 1 illustrates the selective laser sintering process and apparatus 100 of the present invention. The method and apparatus advantageously provides a polishing pad having a continuously interconnected porous structure wherein the porosity and the material of construction is controlled as desired. The polishing pad of the present invention has particular utility in electrochemical mechanical polishing applications. Referring back to FIG. 1, the apparatus 100 provides an enclosed reaction vessel 36 containing an inert gas, such as, nitrogen, to reduce unwanted interaction with the atmosphere. As used herein, an “inert gas” is any gas that lacks a usual or anticipated chemical or biological reaction. In addition, the vessel 36 is temperature controlled, namely, at a temperature that more easily facilitates the selective laser sintering of the desired thermoplastic particles. In other words, by maintaining the temperature near the operating temperature of the laser sintering process, the present invention allows for the selective laser sintering to occur at a more rapid rate since the laser 10 need only impart a minimal temperature increase, thereby providing cost effective processing of the laser sintered polishing pad.

Apparatus 100 further comprises a thermal laser 10 to provide the energy for sintering the thermal plastic particles 16 (“thermoplastic particles”). The laser beam is directionally controlled and modulated using a galvanometer or scanner based application system 12. The thermoplastic particles 16 are positioned and compacted in the sintering chamber 18 using a dispensing rod (“dispenser”) 14 that sweeps the particles 16 into the chamber 18. The chamber 18 is created by lowering the retractable table or surface 20, creating a “void” that is sufficient for holding an appropriate quantity of thermoplastic particles 16 to form a sintered polishing layer or pad. In this way, the sintered polishing pad of the present invention may be formed by a single or multiple sintered layers, as desired.

Thermoplastic polymers 16 are generally viscoelastic, and their temperature/viscosity behavior can be complex. At low temperatures, polymers behave as glassy, brittle solids, exhibiting predominantly elastic behavior. The upper temperature boundary for this region is often referred to as the glass transition temperature or “Tg”. Above the Tg, but below the melting point of the polymer, viscous characteristics become more significant and polymers exhibit both viscous and elastic effects. In this region, the polymer is capable of considerable deformation when stress is applied. When the stress is removed, complete recovery may not occur, due to permanent movement and rearrangement of the molecular structure of the polymer. Above the melting point, the polymer tends to behave as a viscous liquid, generally exhibiting permanent deformation when stress is applied.

The processes of the present invention are preferably conducted below the melting point of the thermoplastic particulate material employed. Above the melting point of the material, rapid liquid sintering makes the process difficult to control, particularly since a precisely regulated and uniform pore structure is preferred. Also above the melting point, thermal gradients tend to cause variations in sintering rate and can cause a non-uniform pore structure in the final article. Also, sintering above the polymer's melt temperature tends to cause unwanted deformation of the sintered product due to viscous flow.

Note, thermoplastics can be readily converted into a powder using conventional techniques, such as, cryogenic milling, and the powdered thermoplastics will generally exhibit well defined thermal characteristics, including thermal stability as temperatures approach the thermoplastic's melting point. The thermoplastic material can be selected according to hardness, elastic moduli, chemical durability, and abrasion resistance. Examples of thermoplastic polymers that may be used in the processes of the present invention are polyurethanes, polyamides, polycarbonates, polyacrylates (including methacrylates and acrylates), polysulfones, polyesters, polyolefins and mixtures and copolymers thereof.

Preferably, the thermoplastic polymers of the present invention are sufficiently hydrophilic to provide a critical surface tension greater than or equal to 34 milliNewtons per meter, more preferably greater than or equal to 37 milliNewtons per meter and most preferably greater than or equal to 40 milliNewtons per meter. Critical surface tension defines the wettability of a solid surface by noting the lowest surface tension a liquid can have and still exhibit a contact angle greater than zero degrees on that solid. Thus, polymers with higher critical surface tensions are more readily wet and are therefore more hydrophilic.

Preferred thermoplastic particles 16 comprise urethanes, carbonates, amides, sulfones, vinyl chlorides, acrylates, methacrylates, vinyl alcohols, esters or acrylamides. Useful thermoplastics (from which a powder can be made) in accordance with the present invention have a modulus of 1 to 200 MegaPascal and an elongation to break in the range of 25% to 1000%, more preferably 50%-500% and most preferably 100%-350%.

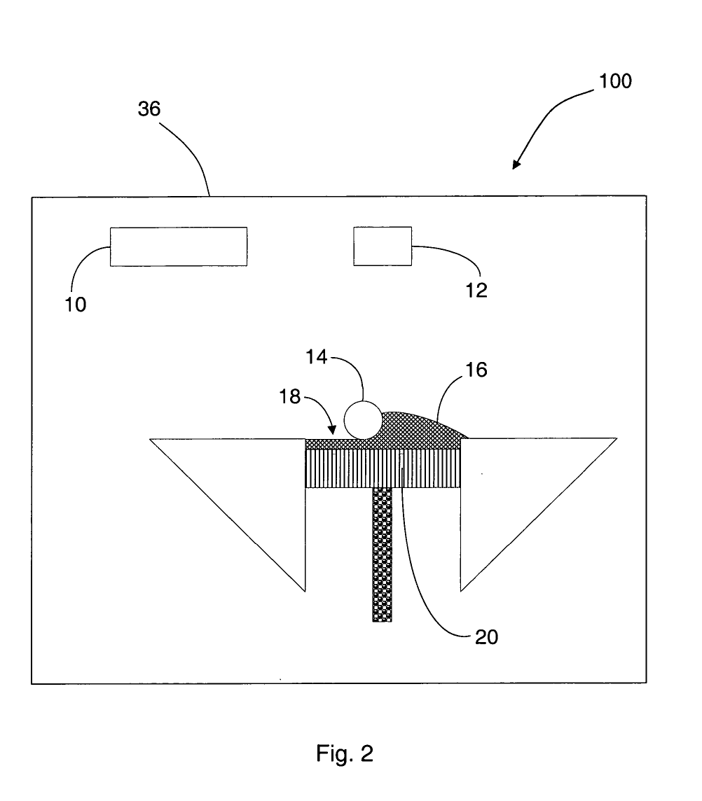

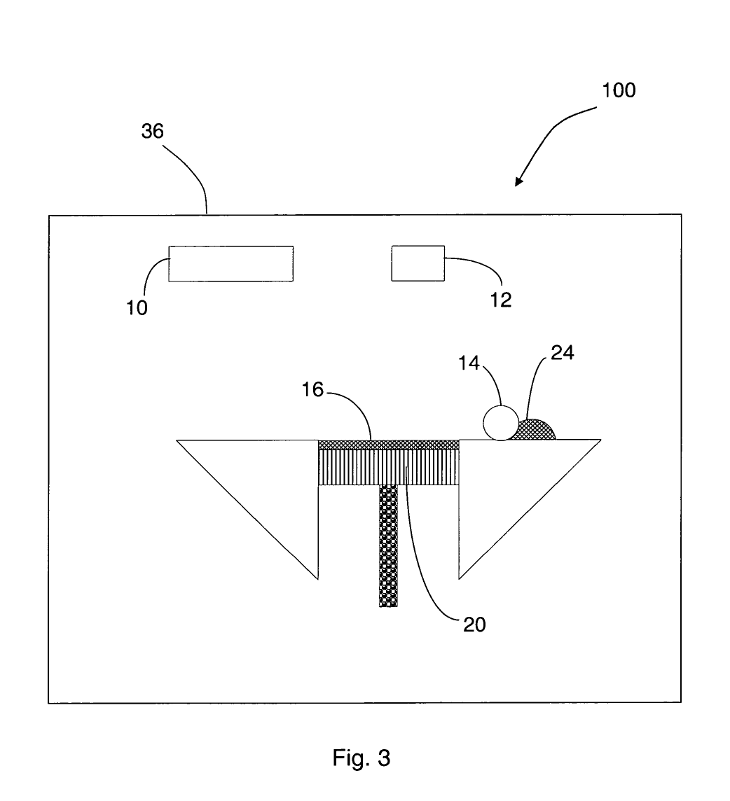

Referring now to FIGS. 2 and 3, the dispenser 14 sweeps or dispenses the particles 16 into the sintering chamber 18. The particles 16 are swept into the sintering chamber 18 with any excess powder supply 24 moved out and away of the region that is to be sintered. In this way, the thermoplastic particles 16 are uniformly contained and distributed within the sintering chamber 18. The volume and depth of the sintering chamber 18 is modified as desired by, for example, by retracting the retractable surface 20 to correspond to the desired sintered layer thickness to be formed with the thermal laser 10.

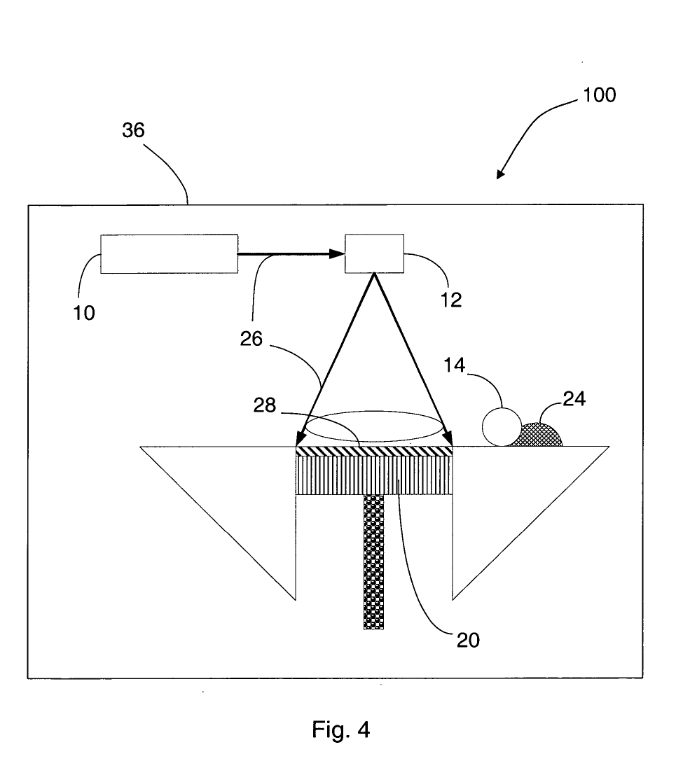

Referring now to FIG. 4, once the sintering chamber 18 has been filled, the thermoplastic particles 16 are then subjected to the specific sintering conditions established by the laser beam 26 from the laser 10 to form the sintered thermoplastic layer 28. In particular, the thermoplastic particles 16 in the presence of the laser beam 26 from the thermal laser 10 are raised above the glass transition temperature to form the sintered thermoplastic layer 28 and further modified, as desired, to form the polishing pad of the present invention. For example, a single layer may have a thickness between 0.1 mm to 0.6 mm, preferably, between 0.15 mm to 0.3 mm. Hence, for example, in order to manufacture a sintered polishing pad with a thickness of 80 mils (2.03 mm), the laser 10 may complete up to 20 separate passes of the laser beam on the particles 16 in the chamber 18, forming multiple sintered layers having a thickness of 4 mils (0.1 mm) each.

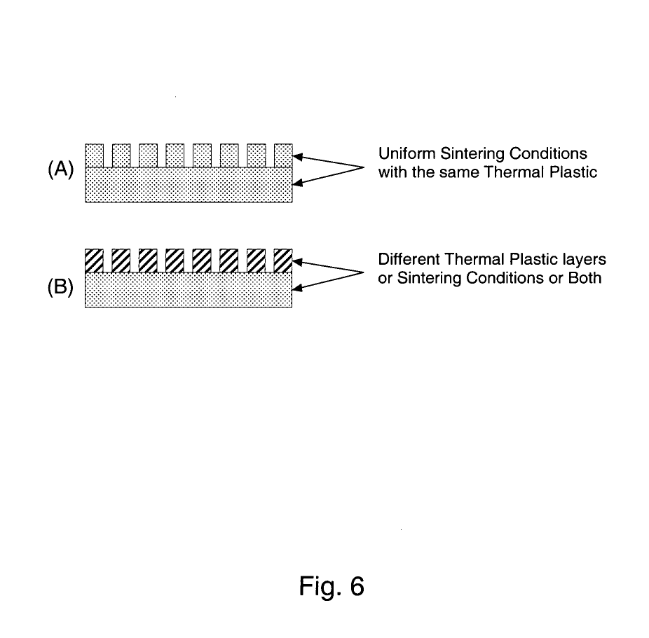

In addition, the intensity, pattern, and duration of the exposure of the thermoplastic particles 16 to the laser beam 26 may be tuned to create the desired, specific polishing pad geometric features. Also, the thermal laser 10 may be configured to only sinter certain areas with the laser beam 26, allowing the non-contacted areas to remain un-sintered and removed from the pad, for example, by simply brushing or shaking off the un-sintered particles. In this way, the present invention allows creation of grooves or other functional areas within the pad by controlling the relationship between the sintered and non-sintered regions (further described with respect to FIG. 6 below). In addition, the porosity and material composition can be altered as a function of the thermoplastic properties itself or by varying the ratio of the thermoplastic particles 16.

Preferably, the polishing pad of the present invention has a porosity between 10 to 50 percent. More preferably, the polishing pad has a porosity between 10 to 40 percent. Most preferably, the polishing pad has a porosity between 20 to 30 percent. In addition, the polishing pad of the present invention has a density between 0.3 g/cm³ to 1.5 g/cm³. More preferably, the polishing pad has a density of about 0.5 g/cm³ to about 1.4 g/cm³. Most preferably, the polishing pad has a density of about 0.8 g/cm³ to about 1.2 g/cm³.

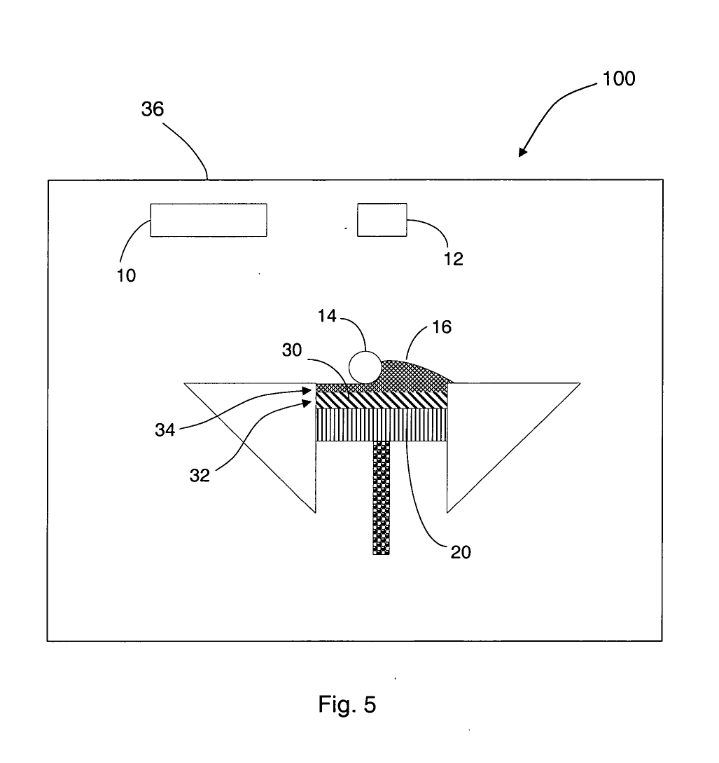

Referring now to FIG. 5, a further illustration of the method of forming a multi-layered polishing pad is shown, in particular, a multi-layered pad having a lower sintered polishing layer 30 and an upper sintered polishing layer formed with the thermoplastic particles 16. In particular, the desired thermoplastic particles (to form the sintered polishing layer 30) are positioned and compacted in the first sintering chamber 32 using a dispensing rod 14 that sweeps the particles into a first sintering chamber 32. The first sintering chamber 32 is created by lowering the retractable table 20, creating a void that is sufficient for holding an appropriate quantity of thermoplastic particles to form a desired sintered polishing layer 30. In particular, the apparatus 100 provides a thermal laser 10 to provide the energy for sintering the thermal plastic particles to form the sintered polishing layer 30. The laser beam is directionally controlled and modulated using a galvanometer or scanner based application system 12.

Next, the desired thermoplastic particles 16 are positioned and compacted into the second sintering chamber 34 using the dispensing rod 14 that sweeps the particles 16 into a second sintering chamber 34 to form another (upper) sintered polishing layer. The second sintering chamber 34 is created by further lowering the retractable table 20, creating another void that is sufficient for holding an appropriate quantity of thermoplastic particles 16 to form another sintered polishing layer. In particular, the thermal laser 10 provides a laser beam to energize and sinter the thermoplastic particles 16 to form another sintered polishing layer. The laser beam is again directionally controlled and modulated using a galvanometer or scanner based application system 12.

As discussed above and further illustrated in FIGS. 6A and 6B, various pad geometries using the same or different materials of construction are shown utilizing the method of FIG. 5. For example, FIG. 6A shows a multi-layered polishing pad formed with uniform sintering conditions utilizing the same thermoplastic particles. FIG. 6B shows a multi-layered polishing pad formed, for example, with different thermoplastic layers, different sintering conditions or both. In addition, each of the layers may be comprised of mixtures of thermoplastic materials. As noted above, the intensity, pattern, and duration of the exposure of the thermoplastic particles to the laser beam may be modified to create the desired, specific polishing pad geometric features. Also, the thermal laser may be configured to only sinter certain areas with the laser beam, allowing the non-contacted areas to remain un-sintered and removed from the pad, for example, by simply brushing or shaking off the un-sintered particles. In this way, the present invention allows creation of grooves or other functional areas within the pad by controlling the relationship between the sintered and non-sintered regions. In addition, the porosity and material composition can be altered as a function of the thermoplastic properties itself or by varying the ratio of the thermoplastic particles.

Note, if mixtures of thermoplastic particles are used, then at least about 20 weight percent of the thermoplastic particles are preferably hydrophilic as described above, e.g., provides a critical surface tension greater than or equal to 34 milliNewtons per meter. The different thermoplastic particles or materials can be blended, and powders can be created from the blend. Alternatively, different thermoplastic materials can be made into powders individually and thereafter combined as a blend of dissimilar powders. By combining different thermoplastics, physical properties can be chosen to provide improved processing ability, such as, improved machining. In addition, processing flexibility, such as, back filling porosity can be achieved utilizing the thermoplastic particles of the present invention. Other thermoplastics can be chosen, having improved hydrophilicity, improved elongation to break, improved resistance to plastic flow, etc., to improve pad performance.

While any size particle may be employed, the processes of the present invention preferably use particles having an average diameter in the range of 5 to 500 microns. More preferably, the present invention uses particles having an average diameter in the range of 2 to 200 microns. Such an average diameter range is well suited for laser sintering to produce a macroscopically smooth final pad surface that is free from large gaps or crevices. This improves the mechanical durability of the sintered product and improves the polishing performance of the pad. As sintering proceeds, plastic flow at the particle boundaries leads to particle coalescence and a corresponding shrinkage of the inter-particle void volume.

Although a wide variety of thermoplastic materials are commercially available and usable as starting materials in the present invention, the range of utility may be considerably enhanced by employing mixtures of two different thermoplastic powders. By intimately mixing two materials, composite structures may be produced that have mechanical properties which may be different than either material individually, and dissimilar material mixtures may be produced from materials that cannot be synthesized directly due to material incompatibility. Of particular utility is the use of a mixture wherein one of the components has a lower melting point than the other. When such a mixture is processed at a temperature not to exceed the melting point of the lower melting component, laser sintering may be effected with significantly less chance of distortion.

Preferred combinations of particles include mixtures of particles containing polyurethane with particles containing polyethylene, polypropylene, nylon, polyester or a combination thereof. The polyurethane particles can provide advantageous pad properties (e.g., modulus, elongation to break, critical surface tension, etc.) and the other particles have been found to be particularly useful in improving processability. In one embodiment, at least 10 weight percent of the particles comprise polyurethane, more preferably at least 20 weight percent and most preferably at least 65 weight percent of the particles comprise polyurethane. A preferred particle to be mixed with the polyurethane particles comprises polyethylene.

Note, as discussed above, laser beam from the laser 10 can be moved in any direction (i.e., x, y or z plane) to accommodate numerous designs or configurations as desired. In addition, any supporting member (e.g., table 20) may be moved relative to the laser beam to further accommodate numerous designs or configurations as desired. In addition, the retractable table 20 may be temperature controlled (e.g., by chilling) to reduce the heat and reduce the production time.

In the present embodiment, the laser 10 used for laser sintering may be pulsed thermal lasers that have a relatively low duty cycle. Optionally, laser 12 may be a continuous laser that is shuttered (i.e., the pulse width (time) is very short compared to the time between pulses). The peak intensity and fluence of the laser is given by:

Intensity (Watts/cm²)=peak power (W)/focal spot area (cm²)

Fluence (Joules/cm²)=laser pulse energy (J)/focal spot area (cm²)

while the peak power is:

Peak power (W)=pulse energy (J)/pulse duration (sec)

Example lasers are STS™ Series lasers from PRC Laser Corporation. Thermal laser ablation is preferred.

Accordingly, the present invention provides a method for producing a polishing pad using thermal laser ablation techniques. In particular, a polishing pad can be formed having predetermined final pad geometries and specific features, such as, grooves. In addition, porosity and material composition can be altered as a function of the thermoplastic properties, laser ablation conditions and by varying the ratio of the thermoplastic particles.

What is claimed is:

1. A method of manufacturing a porous chemical mechanical polishing pad comprising:
retracting a retractable surface to form a sintering chamber;
dispensing thermoplastic particles into the sintering chamber via a dispenser;
focusing a laser beam from a laser onto the thermoplastic particles; and
selectively sintering the thermoplastic particles with the laser beam.

2. The method of claim 1 wherein the sintered thermoplastic particles has an average particle size between 5 to 500 microns.

3. The method of claim 1 wherein the particles comprise a thermoplastic selected from urethanes, carbonates, amides, sulfones, vinyl chlorides, acrylates, methacrylates, vinyl alcohols, esters and acrylamides.

4. The method of claim 1 wherein the polishing pad has a porosity of about 10 to 50 percent.

5. The method of claim 1 wherein the polishing pad has a density of about 0.3 g/cm³ to about 1.5 g/cm³.

6. A method of manufacturing a porous chemical mechanical polishing pad comprising:
retracting a retractable surface to form a first sintering chamber;
dispensing first thermoplastic particles into the first sintering chamber via a dispenser;
focusing a laser beam from a laser onto the first thermoplastic particles;
selectively sintering the first thermoplastic particles with the laser beam;
retracting the retractable surface to form a second sintering chamber;
dispensing second thermoplastic particles into the second sintering chamber via the dispenser;
focusing the laser beam from the laser onto the second thermoplastic particles; and
selectively sintering the second thermoplastic particles with the laser beam.

7. The method of claim 6 wherein at least 10 weight percent of the particles comprise polyurethane.

8. The method of claim 6 wherein the particles comprise a mixture of particles containing polyurethane and particles containing a material selected from the group consisting of polyethylene, polypropylene, nylon, polyester and combinations thereof.

9. The polishing pad of claim 6 wherein the mixture comprises thermoplastic polymers selected from the group consisting of polyurethanes, polyamides, polycarbonates, polyacrylates, methacrylates, acrylates, polysulfones, polyesters, polyolefins and mixtures and copolymers thereof.

10. A method of manufacturing a porous chemical mechanical polishing pad comprising:
retracting a retractable surface to form a first sintering chamber;
dispensing thermoplastic particles into the first sintering chamber via a dispenser;
focusing a laser beam from a laser onto the thermoplastic particles;
selectively sintering the thermoplastic particles with the laser beam;
retracting the retractable surface to form a second sintering chamber;
dispensing the thermoplastic particles into the second sintering chamber via the dispenser;
focusing the laser beam from the laser onto the thermoplastic particles; and
selectively sintering the thermoplastic particles with the laser beam.
